(19) United States
(12) Patent Application Publication
(10) Pub. No.: US 2026/0057113 A1
(43) Pub. Date: Feb. 26, 2026

(54) SYSTEMS AND METHODS FOR VERIFYING INFORMATION ACQUIRED FROM MULTIPLE SENSORS BY PROJECTING KNOWN DATA

(71) Applicant: Toyota Motor Engineering & Manufacturing North America, Inc., Plano, TX (US)

(72) Inventor: Michael Allen Clifford, Mountain View, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/813,394

(22) Filed: Aug. 23, 2024

(51) Int. Cl. G06F 21/64

(52) U.S. Cl. CPC G06F 21/64

(57) ABSTRACT

Systems, methods, and other embodiments described herein relate to projecting known data into an overlapping field-of-view (FOV) between multiple sensors and detecting the known data for verifying sensor operation and information from the multiple sensors. In one embodiment, a method includes projecting known data using a projector within a FOV of multiple sensors. The method also includes acquiring information within an overlapping FOV that includes the known data. The method also includes indicating a verification for one of the multiple sensors and communicating the information for executing a downstream task upon detecting the known data.

### TECHNICAL FIELD

The subject matter described herein relates, in general, to verifying information acquired from multiple sensors, and, more particularly, projecting the known data into an overlapping field-of-view and detecting the known data for verifying sensor operation.

### BACKGROUND

Sensors generate data that facilitate perceiving other obstacles, objects, etc., about a surrounding environment. For example, a vehicle equipped with a light detection and ranging (LIDAR) sensor uses light to scan the surrounding environment, while logic associated with the LIDAR analyzes acquired data for detecting object presence within the surrounding environment. Other sensors such as cameras can acquire information about the surrounding environment from which a system derives awareness about aspects of the surrounding environment. This sensor data can be useful in various circumstances for improving perceptions about the surrounding environment so that systems such as automated driving systems (ADS) can safely plan paths and navigate a vehicle.

In various implementations, sensors encounter errors from external factors and malicious attacks. For example, unusual weather and dirt obscure vehicle radar and camera sensors that cause misinterpretations about the surrounding environment. Additionally, electromagnetic interference from nearby electronic sources disrupt sensor signals that cause data inaccuracies and false readings. Miscalibration during manufacturing can also result in incorrect readings that impacts sensor reliability. In another example, malicious interference from hackers manipulates data acquired by vehicle sensors, causing safety hazards for control tasks executed by vehicle systems. Therefore, systems relying upon data acquired from sensors can be hampered by errors and attacks, thereby reducing system performance.

### SUMMARY

In one embodiment, example systems and methods relate to projecting known data into an overlapping field-of-view (FOV) between multiple sensors and detecting the known data for verifying sensor operation and information from the multiple sensors. In various implementations, sensors (e.g., cameras) generate inaccurate data due to physical damage and environmental factors. For instance, road debris can damage vehicle radar and ice can obscure images captured by a vehicle camera about a surrounding environment. Sensors can also degrade from wear and tear diminishing data accuracy that leads to safety incidents, particularly involving automated driving. Furthermore, a system (e.g., a vehicle) can have sensors that operate at different frequencies yet sense a same FOV. For example, an imaging device senses electromagnetic energy within a FOV from frequencies of visible-light frequencies while a ranging device senses at radio frequencies. Here, the imaging device and the ranging device can be vulnerable to a spoofing attack involving an attacker that exploits sensing vulnerabilities. For example, a vehicle camera perceives a pedestrian crossing a road involving the spoofing attack using fake scenery (e.g., a sign) when the road is actually clear. This attack can cause an automated driving system (ADS) to abruptly and dangerously stop a vehicle. Therefore, perceiving features about an environment using data acquired from multiple sensors face challenges from reading errors, hardware degradation, and malicious attacks.

Therefore, in one embodiment, a verification system tests multiple sensors having an overlapping FOV through projecting known data (e.g., an image) and sensing the known data along with other information. For example, the verification system trusts acquired information from a sensor (e.g., a camera) of a sensor system upon detecting the known data within the overlapping FOV and successful comparisons by multiple sensors. Upon the sensor failing the test due to malfunction, the sensor system can also trust information acquired from another sensor. In one approach, the verification system projects an encoded image unto a road using a projector disposed on a vehicle. Here, a radar sensor and a camera may have an overlapping FOV and the encoded image includes a number decodable by the vehicle. For instance, an attacker attempts to fool the radar sensor using reflective signs on the road. The vehicle can trust information from the camera over the radar sensor when the camera senses the encoded image and the vehicle decodes the number without error. Accordingly, the verification system identifies certain sensors within a system functioning properly and free of a spoofing attack through detecting known data that is projected within an overlapping FOV, thereby increasing system reliability and robustness.

In one embodiment, a verification system that projects known data into an overlapping FOV between multiple sensors and detects the known data for verifying sensor operation and information from the multiple sensors is disclosed. The verification system includes a memory storing instructions that, when executed by a processor, cause the processor to project known data using a projector within a FOV of multiple sensors. The instructions also include instructions to acquire information within an overlapping FOV that includes the known data. The instructions also include instructions to indicate a verification for one of the multiple sensors and communicate the information for executing a downstream task upon detection of the known data.

In one embodiment, a non-transitory computer-readable medium for projecting known data into an overlapping FOV between multiple sensors and detecting the known data for verifying sensor operation and information from the multiple sensors and including instructions that when executed by a processor cause the processor to perform one or more functions is disclosed. The instructions include instructions to project known data using a projector within a FOV of multiple sensors. The instructions also include instructions to acquire information within an overlapping FOV that includes the known data. The instructions also include instructions to indicate a verification for one of the multiple sensors and communicate the information for executing a downstream task upon detection of the known data.

In one embodiment, a method for projecting known data into an overlapping FOV between multiple sensors and detecting the known data for verifying sensor operation and information from the multiple sensors is disclosed. In one embodiment, the method includes projecting known data using a projector within a field-of-view (FOV) of multiple sensors. The method also includes acquiring information within an overlapping FOV that includes the known data. The method also includes indicating a verification for one of the multiple sensors and communicating the information for executing a downstream task upon detecting the known data.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a verification system that is associated with projecting known data into an overlapping field-of-view (FOV) between multiple sensors and detecting the known data for verifying sensor operation.

FIGS. 3A and 3B illustrate one embodiment of testing sensors having an overlapping FOV through projecting known data.

FIG. 4 illustrates one embodiment of testing sensors through projecting known data in a vehicle environment involving a merging vehicle.

FIG. 5 illustrates one embodiment of a method that is associated with acquiring information within the overlapping FOV including the known data and identifying trustable sensors.

### DETAILED DESCRIPTION

Systems, methods, and other embodiments associated with projecting known data into an overlapping field-of-view (FOV) between multiple sensors and detecting the known data for verifying sensor operation and information from the multiple sensors are disclosed herein. In various implementations, information acquired from a sensor system is subject to errors and failure caused from environmental factors and hacker attacks. For instance, a bumpy road causes reading errors by a sonar sensor of a vehicle. Furthermore, an attacker can project an image of a non-existence object (e.g., a human) into a camera FOV during a spoofing event. Here, a system can mistakenly perceive the existence of the object from the attack and erroneously execute a task. Environmental factors or an attacker can also cause a conflict involving multiple sensors perceiving a same FOV differently. For example, a vehicle radar detects frequencies of light beyond visible-light while a camera senses visible-light frequencies. As such, a system may perceive an object using image data from the camera while radar data could lack information about the object. Employing redundancies within sensor systems can mitigate errors but increase manufacturing costs and complexity. Thus, systems executing tasks using information can have decreased reliability from sensing errors, malicious attacks, and conflicts.

Therefore, in one embodiment, a verification system tests a sensor system through projecting known data within a FOV of multiple sensors for identifying malfunction and external attacks. For example, testing a camera involves projecting a known image into a FOV area that overlaps and sensing the known image using the camera. A projector disposed on a device (e.g., a vehicle) projects the known image into the FOV (e.g., ahead of the vehicle, a vehicle side, etc.). The sensor system trusts information from the camera about an environment upon the known image being successfully detected from multiple sensors. For instance, a comparison of the known data detected by the camera and a LIDAR sensor within the overlapping FOV indicates a similar result. Otherwise, the sensor system may trust information from another sensor sensing the environment and indicate that the camera is failing, encountering a potential attack, etc. Similarly, the verification system can test multiple sensors having an overlapping FOV for the known data. The multiple sensors can be verified as trustable upon detecting the known data from certain sensors. In this way, the verification system efficiently and effectively tests sensors for faults and spoofing through projecting known data onto a scene.

Moreover, in one embodiment, the known data is information encrypted with a public key, a quick response (QR) code, a QR code encrypted using the public key, etc., that prevents an attack from others projecting known data. Here, a projector on a device (e.g., a vehicle) emits the QR code as an image within an overlapping FOV of multiple sensors associated with a sensor system. As added security, the QR code can be random text that is encoded, a cryptographic hash of the random text, etc. Furthermore, the QR code can also have an expiration time for sensing (e.g., a microsecond, a millisecond, etc.) as additional security. An imaging sensor (e.g., a camera) on the device senses the QR code for verifying information acquired by the sensor system. For instance, sensing the QR code successfully indicates that the camera and a sensor group (e.g., an IR camera, sonar, etc.) sharing the overlapping FOV as being trusted while the sensor system discards information derived from other sensors. In one approach, a sensor is trusted if decoded text derived from the QR code matches original text encoded using the public key associated with the sensor. Accordingly, the verification system improves sensor operation and resolves conflicts through projecting known data that is encoded without increasing hardware costs and complexity.

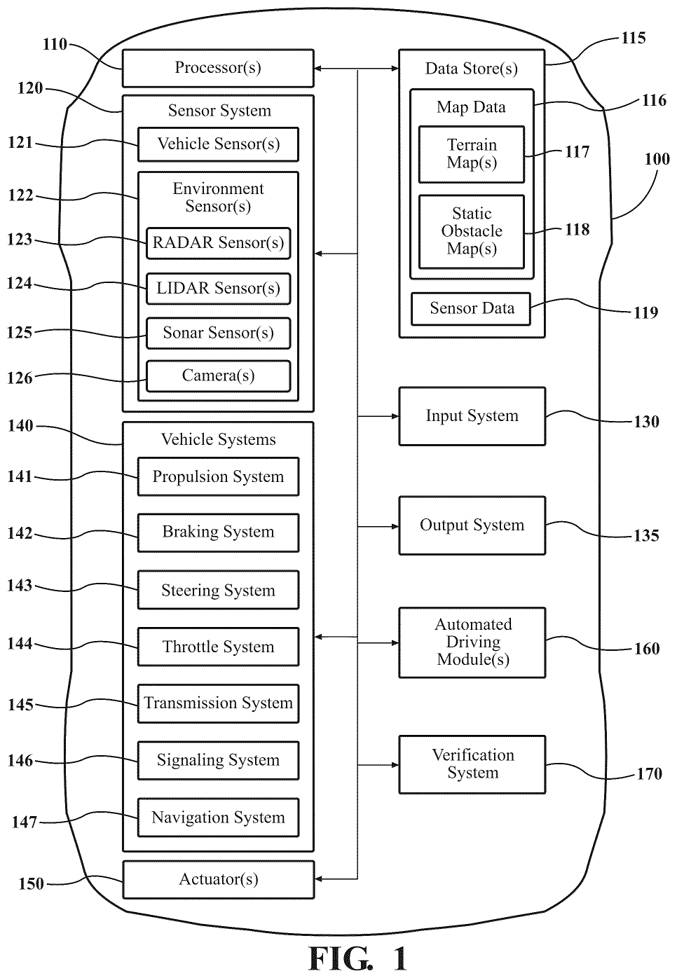

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, a verification system 170 uses road-side units (RSU), consumer electronics (CE), mobile devices, robots, drones, and so on that benefit from the functionality discussed herein associated with projecting known data into an overlapping FOV between multiple sensors and detecting the known data for verifying sensor operation and information from the multiple sensors.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, as discussed, one or more components of the disclosed system can be implemented within a vehicle while further components of the system are implemented within a cloud-computing environment or other system that is remote from the vehicle 100.

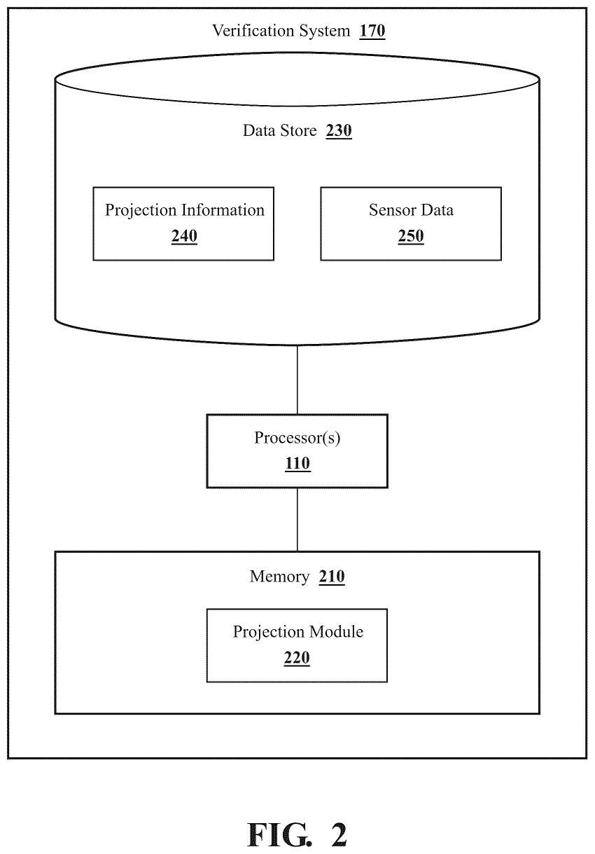

Some of the possible elements of the vehicle 100 are shown in FIG. 1 and will be described along with subsequent figures. However, a description of many of the elements in FIG. 1 will be provided after the discussion of FIGS. 2-5 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes a verification system 170 that is implemented to perform methods and other functions as disclosed herein relating to projecting known data into an overlapping FOV between multiple sensors and detecting the known data for verifying sensor operation and information from the multiple sensors.

With reference to FIG. 2, one embodiment of the verification system 170 of FIG. 1 is further illustrated. The verification system 170 is shown as including a processor(s) 110 from the vehicle 100 of FIG. 1. Accordingly, the processor(s) 110 may be a part of the verification system 170, the verification system 170 may include a separate processor from the processor(s) 110 of the vehicle 100, or the verification system 170 may access the processor(s) 110 through a data bus or another communication path. In one embodiment, the verification system 170 includes a memory 210 that stores a projection module 220. The memory 210 is a random-access memory (RAM), a read-only memory (ROM), a hard-disk drive, a flash memory, or other suitable memory for storing the projection module 220. The projection module 220 is, for example, computer-readable instructions that when executed by the processor(s) 110 cause the processor(s) 110 to perform the various functions disclosed herein. In one approach, the verification system 170 as illustrated in FIG. 2 is generally an abstracted form of the verification system 170 as may be implemented between the vehicle 100 and a cloud-computing environment.

With reference to FIG. 2, the verification system 170 and the projection module 220 generally includes instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the verification system 170, in one embodiment, acquires sensor data 250 that includes at least camera images. In further arrangements, the verification system 170 acquires the sensor data 250 from further sensors such as radar sensors 123, LIDAR sensors 124, sonar sensors 125, and other sensors as may be suitable for identifying vehicles and locations of the vehicles.

Accordingly, the verification system 170, in one embodiment, controls the respective sensors to provide the data inputs in the form of the sensor data 250. Additionally, while the verification system 170 is discussed as controlling the various sensors to provide the sensor data 250, in one or more embodiments, the verification system 170 can employ other techniques to acquire the sensor data 250 that are either active or passive. For example, the verification system 170 passively sniffs the sensor data 250 from a stream of electronic information provided by the various sensors to further components within the vehicle 100. Moreover, the verification system 170 can undertake various approaches to fuse data from multiple sensors when providing the sensor data 250 and/or from sensor data acquired over a wireless communication link. Thus, the sensor data 250, in one embodiment, represents a combination of perceptions acquired from multiple sensors.

Moreover, in one embodiment, the verification system 170 includes a data store 230. In one embodiment, the data store 230 is a database. The database is, in one embodiment, an electronic data structure stored in the memory 210 or another data store and that is configured with routines that can be executed by the processor(s) 110 for analyzing stored data, providing stored data, organizing stored data, and so on. Thus, in one embodiment, the data store 230 stores data used by the verification system 170 in executing various functions. In one embodiment, the data store 230 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on. In one embodiment, the data store 230 further includes projection information 240 that is known data such as an image, an object, a code, encrypted information, a QR code, an encrypted QR code, etc. For example, the QR code includes a hash value of random text with an expiration time that is limited (e.g., a microsecond, a millisecond, etc.).

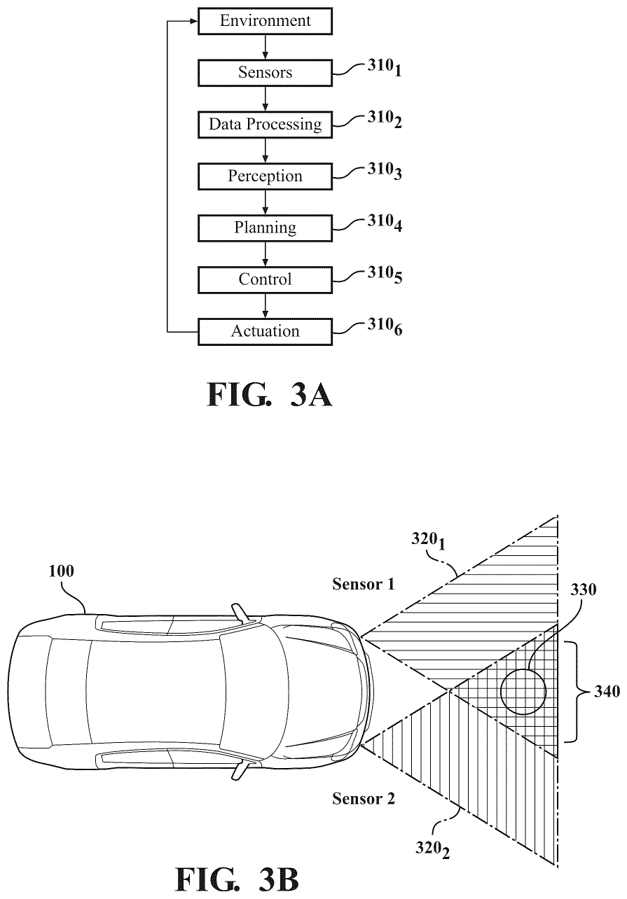

Now turning to FIGS. 3A and 3B, one embodiment of testing sensors having an overlapping FOV through projecting known data is illustrated. In these figures, testing of sensors is illustrated within a vehicle environment and involves a spoofing attack. However, the verification system 170 can be implemented to protect multiple sensors in any sensor system from malfunction, errors, and spoofing attacks through projecting known data within a sensor FOV. Here, the spoofing attack can involve injecting an imaginary object, deleting a real object within an environment, etc. Furthermore, although the example in FIG. 3B involves malicious spoofing and the verification system 170 can similarly test sensors through projecting known data that mitigates reading errors from environmental factors, sensor damage, etc.

The verification system 170 and/or the projection module 220, in one embodiment, are further configured to perform additional tasks beyond controlling the respective sensors to acquire and provide the sensor data 250. For example, the projection module 220 includes instructions that cause the processor 110 to project known data using a projector within a FOV of multiple sensors. The verification system 170 can acquire information within an overlapping FOV that includes the known data. Furthermore, in one approach, the verification system 170 indicates a verification for one of the multiple sensors and communicates the information for a downstream task upon detection of the known data.

In FIG. 3A, a vehicle stack has layers implemented by the vehicle 100 and the verification system 170 where the vehicle stack acquires the sensor data 250 and the vehicle 100 executes computing tasks. Here, sensors layer 310₁ acquires data about an environment that is organized and formatted through data processing layer 310₂. A perception layer 310₃ can detect information about objects and features within the environment using outputted data from the data processing layer 310₂ using a physical model. In one approach, the verification system 170 uses a machine learning (ML) model that is data-driven for detecting the objects. For example, a neural network (NN), a convolutional neural network (CNN), etc., trains to perform semantic segmentation over the sensor data 250 from which further information is derived. Of course, in further aspects, the verification system 170 may employ different machine learning algorithms or implements different approaches for performing the associated functions, which can include deep convolutional encoder-decoder architectures, or another suitable approach that generates semantic labels for the separate object classes represented in the image. Whichever particular approach the verification system 170 implements, the verification system 170 provides an output with semantic labels identifying objects represented in the sensor data 250.

Moreover, a planning layer 310₄ processes outputs from perception layer 310₃ to generate a path for the vehicle 100. Here, the path can be a trajectory for an automated driving system (ADS) to execute using the control layer 310₅ that can generate driving commands such as one of acceleration, braking, and steering commands. The actuation layer 310₆ can receive the driving commands and signal vehicle components to follow the driving commands. A loop can include the sensors layer 310₁ acquiring additional data about the environment from changes caused by executing the driving commands during travel.

FIG. 3B illustrates the vehicle 100 having a sensor 1 and a sensor 2 that can acquire the sensor data 250 having information about a vehicle environment using the sensors layer 310₁. The sensor 1 and sensor 2 can be an individual sensor, a sensor array, the sensor system 120, etc. Here, sensor 1 has a FOV 320₁ and sensor 2 has a FOV 320₂. In an example, an attacker spoofs sensor readings and targets the sensors layer 310₁ for compromising the FOV 320₂. For instance, the sensor 2 includes the LIDAR sensors 124 used by the automated driving module(s) 160 and the attacker syncs with emissions from the LIDAR sensors 124. The spoofing continues by the attack emitting a LIDAR response (e.g., a return pulse) that is fake to the LIDAR sensors 124. The vehicle 100 senses the LIDAR response and the sensor system 120 records altered data during scanning by the LIDAR sensors 124, thereby effectuating the attack.

Moreover, the spoofing alters environmental features identified by the perception layer 310₃ when verification and testing are lacking. Correspondingly, the perception layer 310₃ may classify and identify objects (e.g., human, traffic light, etc.) using a point cloud generated by the LIDAR sensors 124 that is effectively a false representation about the environment. For example, a point cloud is a set of data points in three-dimensional (3D) space representing external surfaces of an object, environment, etc. As such, the vehicle 100 and the planning layer 310₄ erroneously make decisions about vehicle actions (e.g., route planning, vehicle commands, etc.) through misclassified objects and environmental features resulting from the spoofing attack.

The verification system 170 mitigates the spoofing attack through projecting object 330 as known data having the projection information 240. In one approach, the projection information 240 is detectable by both sensor 1 and sensor 2 for testing. Here, a successful test can involve a comparison result indicating that the sensor 1 and sensor 2 both accurately detect the projection information 240. The object 330 can be completely, partially, etc., within the overlapping FOV 340. As explained below, the verification system 170 can estimate that information from the sensor 1 is trusted while the sensor 2 lacks trust using testing when the projection information 240 is encrypted. In one approach, a projector is a liquid crystal display (LCD), a digital light processing (DLP), a liquid crystal on silicon (LCoS), etc., projector disposed on the vehicle 100 and emits the object 330 as an image. Furthermore, the image can have information within and outside of visible frequencies that is detectable by the LIDAR sensors 124 within overlapping FOV 340.

Regarding an example of detecting the known data, the sensor 1 can be the one or more cameras 126 sensing the image and the data processing layer 310₂ and the perception layer 310₃ recognizing the known data. Meanwhile, the image goes undetected within the overlapping FOV 340 by the sensor 2 using the LIDAR sensors 124. The sensor 2 can also misidentify, partially detect the known data, detect the known data with missing information, etc., during a detection event that is unsuccessful. In this way, the spoofing attack fails through the verification system 170 identifying information from a comparison indicating that the sensor 1 as verified while designating sensor 2 as unverified and compromised. A failed comparison can also indicate that sensor 1 is malfunctioning. Furthermore, the vehicle 100 can communicate the information acquired from the sensor 1 for a downstream task involving the planning layer 310₄ and the control layer 310_{5.}

In various implementations, the verification system 170 indicates that multiple sensors of the sensor system 120 are verified when the sensor 1 is a group detecting the known data within the overlapping FOV 340. For instance, an attack is limited to LIDAR sensors 124. As such, multiple cameras of the vehicle 100 are verified when a comparison result involving sensor 1 has multiple units from the one or more cameras 126 successfully detecting the image as the known data. Furthermore, a sensor fault, a sensor obstruction, etc., can also be eliminated by the verification system 170 upon the multiple units detecting the known data. Similarly, the verification system 170 identifies a faulty camera and indicates the faulty camera as untrustworthy when the known data goes undetected. Meanwhile, the verification system 170 indicates that information acquired from other ones of the one or more cameras 126 are trustable.

In another approach, the projector emits the known data for testing a camera(s) and LIDAR having information within visible-light frequencies. Here, the known data can go undetected by sensor 1 within the overlapping FOV 340 using the one or more cameras 126. Meanwhile, the LIDAR sensors 124 detects the known data. As such, the verification system 170 indicates through comparing outputs that information from the LIDAR sensors 124 are trustable while the one or more cameras 126 are compromised.

As added security, in one embodiment, the object 330 includes hidden information that mimics a challenge-response protocol. The added security can protect against an attacker projecting an image (e.g., a pedestrian) within a FOV of a vehicle sensor and copying known data emitted by a projector disposed on the vehicle. In this scenario, a spoofing attack involves tricking the verification system 170 through stealing and re-projecting the known data, thereby breaching a security protocol. In one approach, the hidden information is cryptographically random text (e.g., plain text), numbers, etc., representing the known data or embedding within the known data. For instance, the verification system 170 encrypts text using a public key. In various implementations, the encrypted text is embedded within a QR code and a projector disposed on the vehicle 100 emits the QR code within the overlapping FOV 340 using visible-light frequencies. The QR code can be a hash value of random text (e.g., plain text) with an expiration time that is limited. Furthermore, the random text can include a nonce that prevents a reply attack involving an attacker reading projected data and reprojecting the projected data, QR code, etc., at a later time. The one or more cameras 126 of sensor 1 senses the QR code. The vehicle 100 has a private key for sensor 1 stored by the verification system 170 associated with the challenge-response protocol. The verification system 170 indicates the one or more cameras 126 as trustable upon successfully decoding the QR code.

In another embodiment, the sensor 1, the sensor 2, and the verification system 170 each have a public and a private key. Sensor 1 and sensor 2 can make public keys visible to authentication components and the projector. In one approach, a verifier, the projector, etc., generates information having random text, plain text, random text and a nonce, etc., and encrypts the information using a public key of a particular sensor for generating cyphertext. Here, the sensors 1 and 2 can sense (e.g., read) the QR code that is projected to derive the cyphertext that is encoded. Sensor 1 decrypts the cyphertext using a private key particular to sensor 1 and communicates results to an authenticator, the verification system 170, etc. The private key can be embedded within a sensor, such as a secure enclave. A match from comparing the decrypted text to the original random text, random text and nonce, etc., seen by sensors 1 and 2 indicates receiving a valid image. Lacking a match indicates an invalid image and possible attack, sensor error, etc.

In various implementations, verifying that sensors 1 and 2 similarly sense the known data can involve encrypting text using respective public keys of the sensors and forming encrypted data strings. Here, the verification system 170 can concatenate strings representing the encrypted text from sensors 1 and 2 into a combined string that is embedded in a QR code. The sensors 1 and 2 attempt to read the QR code within the overlapping FOV 340 and split the QR code into appropriately sized segments for decrypting various segments with different private keys associated with the sensors 1 and 2. The decryption by sensor 1 can comprise n decrypted segments, where n-1 segments have incorrect data from using the wrong private key. The 1 segment will have the correct data from encrypting using the public key for sensor 1 as other segments are encrypted using public keys for other sensors. The verification system 170 confirms random text (e.g., plain text) within the combined string and segment order matches the original text for sensor 1. In one approach, a verifier component within the verification system 170 solely knows positions that should have a successfully decrypted segment. For instance, the verification system 170 verifies that at time t, sensor m of n sensors observed a string of cyphertext segments having the segment with the public key of sensor m. As such, verification from an attack can involve correctly decrypting the segment in the position m.

Moreover, the verification system 170 can utilize a different random string as text for a segment among n sensors. This prevents collusion among sensors when multiple sensors are controlled by the same attacker, the sensors share decrypted segments, and look for a match between resulting text strings as previously explained. In another approach, a segment, text, etc., embedded within the QR code includes an encoded identifier, signature, etc., that allows the sensor 1 being tested to recognize which QR code to utilize for verification when the projector emits multiple QR codes concurrently. In this way, the verification system 170 prevents a spoofing attack involving copying of known data by an attacker.

The vehicle 100 and the verification system 170, in one embodiment, estimate operator health using information derived from the sensor data 250. Here, multiple sensors having an overlapping FOV can include a cabin camera, a sensor for body temperature within the vehicle 100, etc., associated with the sensor system 120. The sensor for the body temperature may generate erroneous readings, such as due to dust. A conflict can arise through comparison where a monitoring system predicts that the operator is distressed using erroneous data while estimates using images from the cabin camera indicate an operator state that is normal. As such, a projector within the vehicle 100 emits known data having frequencies that are detectable by both the cabin camera and the sensor for the body temperature. The cabin camera detects the known data. The sensor for the body temperature fails to detect the known data. Accordingly, the verification system 170 identifies an error from the conflicting detections through indicating that information acquired from the cabin camera is trustable while information derived from the sensor for the body temperature is untrustworthy.

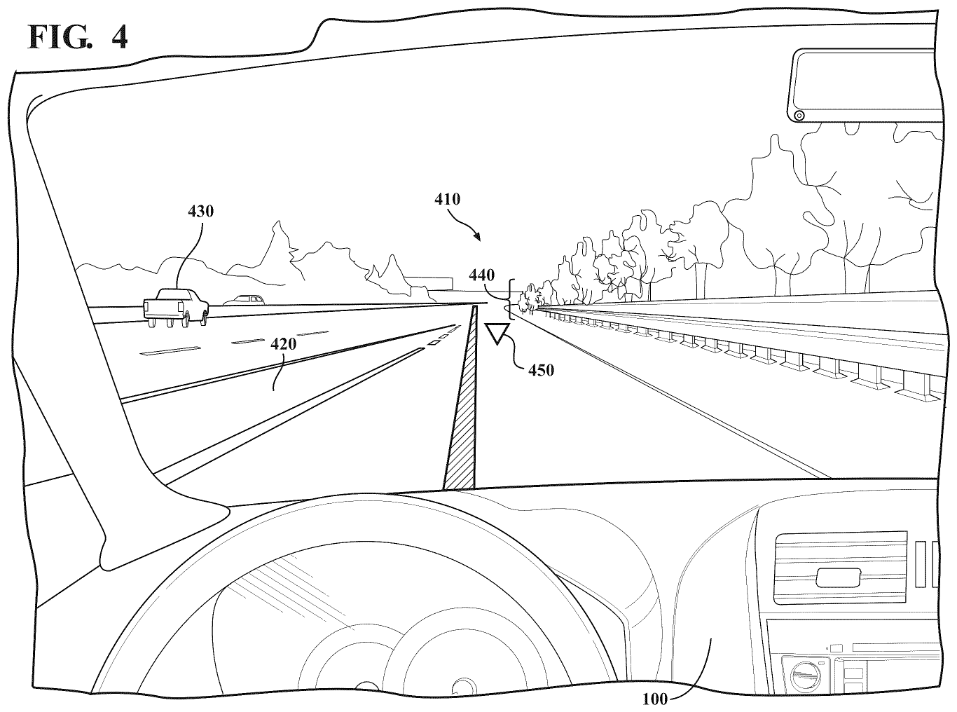

Regarding FIG. 4, one embodiment of testing sensors through projecting known data in a vehicle environment 410 involving the vehicle 100 merging into traffic is illustrated. Here, the vehicle 100 can be merging with a median 420 on the left automatically using the ADS. The traffic on the road includes the pick-up truck 430. In this scenario, a first camera from the one or more cameras 126 erroneously detects and confuses a tree 440 as a vehicle on the road. The verification system 170 can eliminate the fault and verify a second camera from the one or more cameras 126 through projecting an image having encrypted data. The image can be projected unto an overlapping FOV 450 associated with the first camera and the second camera. For example, the verification system 170 identifies the first camera as faulty and untrustworthy when decoding the encrypted data acquired with the first camera fails. Meanwhile, the verification system 170 indicates that information acquired from the second camera is trustable when successfully decoding the encrypted data acquired with the second camera. In this way, the verification system 170 efficiently detects faulty sensors through projecting known data on a road, thereby improving safety.

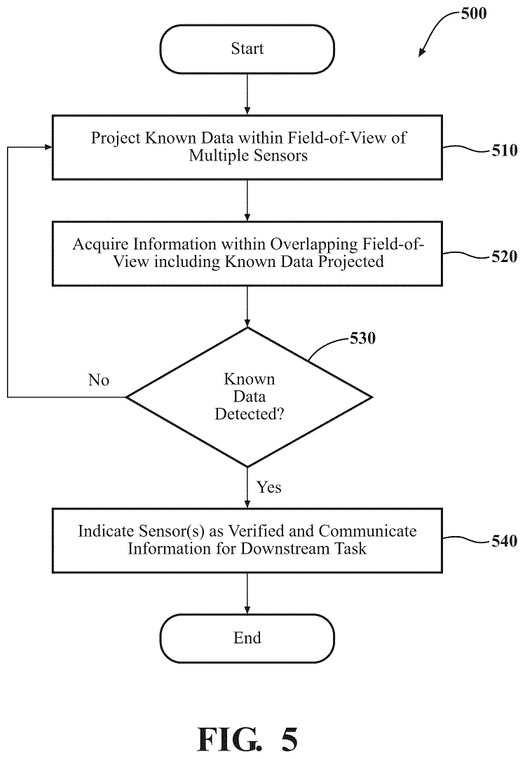

Now turning to FIG. 5, a flowchart of a method 500 that is associated with acquiring information within the overlapping FOV including the known data and identifying trustable sensors is illustrated. The method 500 will be discussed from the perspective of the verification system 170 of FIGS. 1 and 2. While the method 500 is discussed in combination with the verification system 170, it should be appreciated that the method 500 is not limited to being implemented within the verification system 170 but is instead one example of a system that may implement the method 500. For instance, the verification system 170 is implemented outside the vehicle 100 to protect multiple sensors in any sensor system from malfunction and spoofing attacks through projecting known data within a sensor FOV.

At 510, the projection module 220 projects known data within a FOV of multiple sensors. The known data can include the projection information 240 that is one of an image, an object, a code, a QR code, etc. For example, the QR code includes a hash value of encoded random text with an expiration time that is limited (e.g., a microsecond, a millisecond, etc.). A projector disposed on a device (e.g., a vehicle) can project the known data. In one approach, the projector is a LCD, a DLP, a LCoS, etc., projector disposed on the vehicle 100 and emits the projection information 240. In another approach, a projector integrated within the LIDAR sensors 124 emits the known data as a LIDAR response having information within visible-light frequencies. The projection information 240 can be completely, partially, etc., within an overlapping FOV for testing.

At 520, the verification system 170 acquires information within an overlapping FOV including the known data that was projected by the projection module 220. As previously explained, the verification system 170 can mitigate a spoofing attack by the known data being successfully detectable with multiple sensors for testing. For example, the projection information 240 is an image having information within and outside of visible frequencies that is detectable by the LIDAR sensors 124 and the one or more cameras 126. A spoofing attack can involve injecting an imaginary object, deleting a real object within an environment, etc.

At 530, the verification system 170 detects the projection information 240 as the known data using images from multiple cameras from the one or more cameras 126 within the overlapping FOV. Meanwhile, the projection information 240 goes undetected by the LIDAR sensors 124. In one approach, the LIDAR sensors 124 detect the known data with missing information, misidentify the known data, partially detect the known data, etc. As such, a spoofing attack fails through the verification system 170 identifying information from the one or more cameras 126 as verified while designating the LIDAR sensors 124 as unverified and compromised. In another approach, the known data being a LIDAR response having information within and outside of visible-light frequencies goes undetected by the one or more cameras 126. Meanwhile, the LIDAR sensors 124 detects the known data, thereby indicating a sensor malfunction.

At 540, the verification system 170 indicates a sensor(s) as verified and communicates the information for a downstream task upon the sensor(s) successfully detecting the known data after comparing detections from multiple sensors. Otherwise, the verification system 170 outputs that a sensor(s) is malfunctioning, a sensor(s) may be compromised (e.g., a spoofing attack), the projector is malfunctioning, etc. The verification system 170 can also project known data again within the FOV of multiple sensors at 510 for processing additional information when known data goes undetected by the sensor(s). In the example given for 530, the verification system 170 can indicate that one of the LIDAR sensors 124 and the one or more cameras 126 are verified. In another approach, an indication can identify that multiple sensors of the sensor system 120 are verified upon validating either one of the LIDAR sensors 124 and the one or more cameras 126. For instance, multiple cameras of the vehicle 100 are verified when a camera from the one or more cameras 126 detects an image as the known data.

The verification system 170, in one embodiment, can communicate the information acquired from the sensor(s) for a downstream task upon verification. For example, the vehicle 100 uses information from the LIDAR sensors 124 for planning a path involving the automated driving module(s) 160. In another approach, a security system identifies an intruder using verified information acquired from the one or more cameras 126 and communicates an alarm signal to dispatch with less concerns about a false positive. Accordingly, the verification system 170 increases reliability and decreases false positives for sensor systems through resolving conflicts by projecting and comparing known data without increasing complexity.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate to the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the verification system 170, and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110, the verification system 170, and/or the automated driving module(s) 160 may control some or all of the vehicle systems 140 and, thus, may be partially or fully autonomous as defined by the society of automotive engineers (SAE) levels 0 to 5.

The processor(s) 110, the verification system 170, and/or the automated driving module(s) 160 can be operatively connected to communicate with the various vehicle systems 140 and/or individual components thereof. For example, the processor(s) 110, the verification system 170, and/or the automated driving module(s) 160 can be in communication to send and/or receive information from the various vehicle systems 140 to control the movement of the vehicle 100. The processor(s) 110, the verification system 170, and/or the automated driving module(s) 160 may control some or all of the vehicle systems 140.

The processor(s) 110, the verification system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the verification system 170, and/or the automated driving module(s) 160 can control the direction and/or speed of the vehicle 100. The processor(s) 110, the verification system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the verification system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A verification system comprising:
a memory storing instructions that, when executed by a processor, cause the processor to:
project known data using a projector within a field-of-view (FOV) of multiple sensors;
acquire information within an overlapping FOV that includes the known data; and
upon detection of the known data, indicate a verification for one of the multiple sensors and communicate the information to execute a downstream task.

2. The verification system of claim 1, wherein the instructions to indicate the verification further include instructions to:
estimate that another one of the multiple sensors is unverified from a failed comparison of the known data, wherein the failed comparison indicates one of a sensor malfunction and a spoofing attack; and
wherein the multiple sensors include a radar sensor and a camera.

3. The verification system of claim 1, wherein the instructions to project the known data further include instructions to:
encrypt random text using a public key within a quick response (QR) code, the public key associated with the one of the multiple sensors;
emit by the projector the QR code into the FOV, wherein the projector is disposed on a vehicle; and
sense by a camera from the multiple sensors the QR code.

4. The verification system of claim 3, wherein the instructions to indicate the verification further include instructions to:
decrypt cyphertext from the QR code using a private key associated with the one of the multiple sensors; and
compare the cyphertext with the random text for a match.

5. The verification system of claim 4, wherein the QR code includes a hash of the random text and a nonce and the QR code is associated with an expiration time that is limited.

6. The verification system of claim 1, wherein the instructions to indicate the verification further include instructions to:
estimate that the one of the multiple sensors is verified from a successful comparison of the known data within the overlapping FOV.

7. The verification system of claim 1 further including instructions to:
estimate that another one of the multiple sensors is unverified when misidentifying the known data, wherein the multiple sensors include a radar sensor and a camera and the projector emits an image as the known data.

8. The verification system of claim 1 further including instructions to:
estimate operator health within a vehicle by comparing the information, wherein the multiple sensors include a cabin camera and a sensor for body temperature within the vehicle.

9. A non-transitory computer-readable medium comprising:
instructions that when executed by a processor cause the processor to:
project known data using a projector within a field-of-view (FOV) of multiple sensors;
acquire information within an overlapping FOV that includes the known data; and
upon detection of the known data, indicate a verification for one of the multiple sensors and communicate the information to execute a downstream task.

10. The non-transitory computer-readable medium of claim 9, wherein the instructions to indicate the verification further include instructions to:
estimate that another one of the multiple sensors is unverified from a failed comparison of the known data, wherein the failed comparison indicates one of a sensor malfunction and a spoofing attack; and
wherein the multiple sensors include a radar sensor and a camera.

11. The non-transitory computer-readable medium of claim 9, wherein the instructions to project the known data further include instructions to:
encrypt random text using a public key within a quick response (QR) code, the public key associated with the one of the multiple sensors;
emit by the projector the QR code into the FOV, wherein the projector is disposed on a vehicle; and
sense by a camera from the multiple sensors the QR code.

12. The non-transitory computer-readable medium of claim 11, wherein the instructions to indicate the verification further include instructions to:
decrypt cyphertext from the QR code using a private key associated with the one of the multiple sensors; and
compare the cyphertext with the random text for a match.

13. A method comprising:
projecting known data using a projector within a field-of-view (FOV) of multiple sensors;
acquiring information within an overlapping FOV that includes the known data; and
upon detecting the known data, indicating a verification for one of the multiple sensors and communicating the information for executing a downstream task.

14. The method of claim 13, wherein indicating the verification further includes:
estimating that another one of the multiple sensors is unverified from a failed comparison of the known data, wherein the failed comparison indicates one of a sensor malfunction and a spoofing attack; and
wherein the multiple sensors include a radar sensor and a camera.

15. The method of claim 13, wherein projecting the known data further includes:
encrypt random text using a public key within a quick response (QR) code, the public key associated with the one of the multiple sensors;
emitting by the projector the QR code into the FOV, wherein the projector is disposed on a vehicle; and
sensing by a camera from the multiple sensors the QR code.

16. The method of claim 15, wherein indicating the verification further includes:
decrypt cyphertext from the QR code using a private key associated with the one of the multiple sensors; and
compare the cyphertext with the random text for a match.

17. The method of claim 16, wherein the QR code includes a hash of the random text and a nonce and the QR is associated with an expiration time that is limited.

18. The method of claim 13, wherein indicating the verification further includes:
estimating that the one of the multiple sensors is verified from a successful comparison of the known data within the overlapping FOV.

19. The method of claim 13 further comprising:
estimating that another one of the multiple sensors is unverified when misidentifying the known data, wherein the multiple sensors include a radar sensor and a camera and the projector emits an image as the known data.

20. The method of claim 13 further comprising:
estimating operator health within a vehicle by comparing the information, wherein the multiple sensors include a cabin camera and a sensor for body temperature within the vehicle.
